(19) United States
(12) Patent Application Publication
(10) Pub. No.: US 2026/0364510 A1
(43) Pub. Date: Nov. 19, 2026

(54) ADSORBENT BEDS FOR HYDROCARBON REMOVAL WITH INCREASED HYDROTHERMAL STABILITY

(71) Applicant: BASF CORPORATION, Florham Park, NJ (US)

(72) Inventors: William B. DOLAN, Yardley, PA (US); Justin PAN, New York, NY (US); Tobias ECKARDT, Hildesheim (DE); Clinton Anne GREENE, Clinton, NJ (US)

(73) Assignee: BASF CORPORATION, Florham Park, NJ (US)

(21) Appl. No.: 19/129,980

(22) PCT Filed: Dec. 10, 2023
(86) PCT No.: PCT/US2023/083266

§ 371 Date: May 14, 2025

Related U.S. Application Data
(60) Provisional application No. 63/431,722, filed on Dec. 11, 2022.

(51) Int. Cl. B01D 53/04; B01D 53/26; C10L 3/10; C10L 3/12

(52) U.S. Cl. CPC B01D 53/0407; B01D 53/0462; B01D 53/261; C10L 3/106; C10L 3/12; B01D 2253/106; B01D 2253/108; B01D 2256/245; B01D 2257/702; B01D 2257/80; B01D 2259/4146; C10L 2290/08; C10L 2290/542

(57) ABSTRACT

Disclosed in certain embodiments are methods of removing water and hydrocarbons from a gas feed stream during an adsorption step of an adsorption cycle.

### CROSS-REFERENCE TO RELATED APPLICATION(S)

This application claims the benefit of priority of U.S. Provisional Patent Application No. 63/431,722, filed Dec. 11, 2022, the disclosure of which is hereby incorporated by reference herein in its entirety.

### BACKGROUND

Dehydration of natural gas to cryogenic specifications is critical in the pretreatment process for liquified natural gas (LNG) production. Zeolitic molecular sieves are used in such processes because they allow for the natural gas to meet the required dewpoint for liquefaction. Failure to reach this required dewpoint may result in the inability to maintain the necessary gas flow to the liquefaction section, which can constrain or shutdown the production of LNG.

Hydrothermal damage and retrograde condensation in dehydrator vessels during regeneration and adsorption lead to degradation of the molecular sieve adsorbent through leaching of the clay binder and loss of adsorption capacity. In addition, the presence of very heavy hydrocarbons may result in coking that can have a deleterious effect on the molecular sieve. Such effects can result in an increase in pressure drop and an uneven distribution of adsorption and/or regeneration flow, ultimately requiring premature replacement of the adsorbent.

### BRIEF DESCRIPTION OF THE DRAWINGS

The present disclosure is illustrated by way of example, and not by way of limitation, in the figures of the accompanying drawings, in which:

FIG. 1A illustrates an adsorber unit in accordance with at least one embodiment of the disclosure;

FIG. 1B illustrates a variation of the configuration of FIG. 1A which includes multiple adsorber units in accordance with at least one embodiment of the disclosure;

FIG. 2A illustrates another adsorber unit in accordance with at least one embodiment of the disclosure;

FIG. 2B illustrates a variation of the configuration of FIG. 2A which includes multiple adsorber units in accordance with at least one embodiment of the disclosure;

FIG. 3A illustrates another adsorber unit in accordance with at least one embodiment of the disclosure;

FIG. 3B illustrates a variation of the configuration of FIG. 3A which includes multiple adsorber units in accordance with at least one embodiment of the disclosure;

FIG. 4A illustrates another adsorber unit in accordance with at least one embodiment of the disclosure;

FIG. 4B illustrates a variation of the configuration of FIG. 4A which includes multiple adsorber units in accordance with at least one embodiment of the disclosure;

FIG. 5 illustrates a method for removing hydrocarbons and/or water from a gas feed stream in accordance with an embodiment of the disclosure;

FIG. 6 shows a simulated H₂O profile of a zeolite 4A sieve bed at the end of adsorption;

FIG. 7 shows a simulated H₂O profile of a Durasorb™ HD and zeolite 4A sieve bed at the end of adsorption;

FIG. 8 shows outlet H₂O composition and temperature for various simulated adsorber units;

FIG. 9 shows adsorption profiles for zeolite beta showing a decay in the midpoint of the breakthrough time for C6;

FIG. 10 shows adsorption profiles for zeolite beta demonstrating the benefit of removing C8+ from the feed; and

FIG. 11 shows adsorption profiles for 13X zeolite demonstrating the benefit of removing C8+ from the feed.

### SUMMARY

The following presents a simplified summary of various aspects of the present disclosure in order to provide a basic understanding of such aspects. This summary is not an extensive overview of the disclosure. It is intended to neither identify key or critical elements of the disclosure, nor delineate any scope of the particular embodiments of the disclosure or any scope of the claims. Its sole purpose is to present some concepts of the disclosure in a simplified form as a prelude to the more detailed description that is presented later.

One aspect of the present disclosure relates to a method of removing water and hydrocarbons from a gas feed stream comprising water and hydrocarbons during an adsorption step of an adsorption cycle comprises directing the gas feed stream having an initial very heavy hydrocarbon mole fraction and an initial water mole fraction toward an adsorbent bed. In at least one embodiment, the adsorbent bed comprises: a first adsorbent layer to remove water and very heavy hydrocarbons from the gas feed stream, the first adsorbent layer comprising one or more of an amorphous silica adsorbent, an amorphous silica-alumina adsorbent, or a high-silica zeolite adsorbent; and a second adsorbent layer downstream from the first adsorbent layer to remove heavy hydrocarbons, the second adsorbent layer comprising a zeolite. In at least one embodiment, the gas feed stream has a reduced very heavy hydrocarbons mole fraction and a reduced water mole fraction when the gas feed stream reaches the second adsorbent layer. In at least one embodiment, the reduced very heavy hydrocarbons mole fraction is maintained for at least 90% of the duration of the adsorption step. In at least one embodiment, the reduced very heavy hydrocarbons mole fraction is less than or equal to about 90% of the initial very heavy hydrocarbons mole fraction.

In at least one embodiment, the reduced water mole fraction is less than about 90%, about 80%, about 70%, about 60%, about 50%, about 40%, about 30%, about 20%, about 10%, about 9%, about 8%, about 7%, about 6%, about 5%, about 4%, about 3%, about 2%, or about 1% of the initial water mole fraction.

In at least one embodiment, the reduced water mole fraction is less than about 20% of the initial water mole fraction.

In at least one embodiment, the reduced very heavy hydrocarbons mole fraction and/or the reduced water mole fraction is/are maintained for at least 95%, at least 96%, at least 97%, at least 98%, at least 99%, or 100% of the duration of the adsorption step.

In at least one embodiment, the reduced very heavy hydrocarbons mole fraction and/or the reduced water mole fraction is/are maintained for 100% of the duration of the adsorption step.

In at least one embodiment, the reduced water mole fraction is less than or equal to about 500 ppm, about 450 ppm, about 400 ppm, about 350 ppm, about 300 ppm, about 250 ppm, about 200 ppm, about 150 ppm, about 100 ppm, about 50 ppm, about 40 ppm, about 30 ppm, about 20 ppm, about 10 ppm, or about 5 ppm.

In at least one embodiment, the reduced water mole fraction is less than or equal to about 100 ppm, about 50 ppm, about 10 ppm, about 9 ppm, about 8 ppm, about 7 ppm, about 6 ppm, about 5 ppm, about 4 ppm, about 3 ppm, about 2 ppm, or about 1 ppm.

In at least one embodiment, the reduced very heavy hydrocarbons mole fraction is less than or equal to about 200 ppm, about 150 ppm, about 100 ppm, about 50 ppm, about 40 ppm, about 30 ppm, about 20 ppm, about 10 ppm, or about 5 ppm.

In at least one embodiment, the adsorbent of the first adsorbent layer is selective for very heavy hydrocarbons.

In at least one embodiment, the first adsorbent layer comprises the amorphous silica adsorbent and/or the amorphous silica-alumina adsorbent.

In at least one embodiment, the zeolite of the second adsorbent layer is selective for heavy hydrocarbons.

In at least one embodiment, the zeolite of second adsorbent layer comprises one or more of zeolite A, zeolite X, or zeolite Y.

In at least one embodiment, the zeolite of the second adsorbent layer comprises one or more of zeolite 3A, zeolite 4A or zeolite 5A.

In at least one embodiment, the zeolite of the second adsorbent layer comprises one or more of zeolite 13X, zeolite Y, ZSM-5 zeolite, beta zeolite, or zeolite 5A.

In at least one embodiment, the zeolite of the second adsorbent layer is exchanged with an element selected from Li, Na, K, Mg, Ca, Sr, or Ba.

In at least one embodiment, the adsorbent bed further comprises an intermediate adsorbent layer between the first adsorbent layer and the second adsorbent layer to remove additional or remaining water. In at least one embodiment, the intermediate adsorbent layer comprises zeolite 3A or zeolite 4A.

In at least one embodiment, the adsorbent bed further comprises a further adsorbent layer downstream from the second adsorbent layer, the further adsorbent layer comprising an amorphous silica adsorbent or an amorphous silica-alumina adsorbent.

In at least one embodiment, the adsorbent bed further comprises an initial adsorbent layer upstream from the first adsorbent layer, the initial adsorbent layer comprising a water stable adsorbent. In at least one embodiment, the water stable adsorbent is an amorphous silica or amorphous silica-alumina adsorbent.

In at least one embodiment, the gas feed stream is a natural gas feed stream.

In at least one embodiment, a final water mole fraction of the gas feed stream leaving the adsorbent bed is below 1 ppm or below 0.1 ppm.

In at least one embodiment, a final very heavy hydrocarbons mole fraction of the gas feed stream after leaving the adsorbent bed is below 10 ppm or below 1 ppm.

In at least one embodiment, the method further comprises: forming a liquefied natural gas product from the gas feed stream after leaving the adsorbent bed.

In at least one embodiment, the method further comprises: forming a C2+ or C3+ natural gas liquid feed stream from the gas feed stream after leaving the adsorbent bed.

In at least one embodiment, the contacting is performed as part of a thermal swing adsorption process having a cycle time of less or equal to about 8 hours, about 7 hours, about 6 hours, about 5 hours, about 4 hours, about 3 hours, about 2 hours, or about 1 hour.

In at least one embodiment, the method further comprises: prior to directing the gas feed stream toward the adsorbent bed, retrofitting the adsorbent bed by removing and replacing at least a portion of a previously present adsorbent with one or more of the first adsorbent layer or the second adsorbent layer.

In another aspect of the present disclosure, a natural gas purification system is adapted to perform any of the methods of the foregoing embodiments.

In another aspect of the present disclosure, an adsorbent bed adapted for removing hydrocarbons and water from a gas feed stream comprises: a first adsorbent layer comprising one or more of a silica adsorbent or a silica-alumina adsorbent to remove water and very heavy hydrocarbons from the gas feed stream; a second adsorbent layer downstream from the first adsorbent layer, the second adsorbent layer comprising one or more of zeolite 13X, zeolite Y, ZSM-5 zeolite, beta zeolite, or zeolite 5A; and an intermediate adsorbent layer between the first adsorbent layer and the second adsorbent layer, the intermediate adsorbent layer comprising one or more of zeolite 4A or zeolite 5A. In at least one embodiment, a volume ratio of the first adsorbent layer to the second adsorbent layer is selected such that contact of the gas feed stream having an initial very heavy hydrocarbons mole fraction and an initial water mole fraction with the first adsorbent layer results in a reduced very heavy hydrocarbons mole fraction and a reduced water mole fraction prior to contact with the second adsorbent layer.

In another aspect of the present disclosure, a natural gas purification system comprises the adsorbent bed of the preceding embodiment.

### DETAILED DESCRIPTION

The present disclosure relates generally to methods of removing water and hydrocarbons (e.g., heavy hydrocarbons and very heavy hydrocarbons) from a gas feed stream comprising hydrocarbons and water during an adsorption step of an adsorption cycle, as well as to adsorbent beds adapted for the same. Some embodiments relate to a single adsorber unit for removing hydrocarbons (e.g., C5+ or C6+ hydrocarbons, aromatics, aliphatic C8+ or C9+ hydrocarbons, etc.), and water down to cryogenic specifications for producing liquefied natural gas (LNG), rather than utilizing two or more separate adsorber units. Other embodiments relate to the use of multiple adsorber units for performing the same.

As used herein, the term “very heavy hydrocarbons” includes C8+ hydrocarbons (i.e., hydrocarbons having 8 carbons or more), benzene, and toluene. Also as used herein, the term “heavy hydrocarbons” includes one or more of C5, C6, or C7 hydrocarbons, with the proviso that benzene and toluene are excluded. The term “hydrocarbons” by itself should be understood to include both “heavy hydrocarbons” and “very heavy hydrocarbons”.

In general, molecular sieves, such as 4A and 3A zeolites, are often used to dry natural gas feed streams. Although these materials beneficially remove water from natural gas at the conditions of the operating units (i.e., high pressure methane and high water concentration), they are subject to hydrothermal damage. While there are other mechanisms that can damage the sieves (e.g., refluxing) which may be mitigated, hydrothermal damage appears unavoidable.

Silica-based materials have been shown to be highly robust in this application with practical field experience where the adsorbent has lasted more than ten years in comparable environments. In general, molecular sieve 13X is used to remove hydrocarbons C6 and C7. Although these materials beneficially remove these hydrocarbons from natural gas at the conditions of the operating units, they are subject to retrograde condensation and coking of C8+ hydrocarbons.

Some embodiments described herein advantageously utilize an amorphous silica adsorbent, an amorphous silica-alumina adsorbent, a high-silica zeolite adsorbent (e.g., beta zeolite, ZSM-5, high-silica Y zeolite, etc.), or combinations thereof, with a less hydrothermally stable adsorbent (e.g., zeolite 3A, 4A, or 13X) as separate adsorbent layers to produce a robust, longer-lasting adsorbent system. In such embodiments, the mole fractions of water entering the section of an adsorbent bed containing the less hydrothermally stable adsorbent is reduced by the upstream layer of the adsorbent bed. Since there is lower mole fraction of water entering the less hydrothermally stable adsorbent during the adsorption step, there is also less water to desorb during the regeneration step and hence a lower steaming environment is created during regeneration. This is advantageous as it is known to those skilled in the art that a steaming environment can damage zeolites. Moreover, mole fractions of C8+ hydrocarbons can also be reduced by the upstream layer of the adsorbent bed. Without being bound by theory, it is believed that reducing the mole fraction of C8+ hydrocarbons can reduce damage to the less stable adsorbent (e.g., by coke deposition). While adsorbent layers may be distributed across multiple adsorbent beds in different adsorber units, some embodiments can advantageously allow for hydrocarbon adsorption (including heavy hydrocarbons) and water adsorption to be performed in a single adsorber unit while being able to reduce the water mole fraction below a cryogenic maximum. This reduces the total number of adsorber units needed, thus reducing the physical size of the natural gas processing facility.

The adsorption process of the present disclosure, used to remove one of more of heavy hydrocarbons, very heavy hydrocarbons, or water from gas feed streams (e.g., a natural gas feed streams), may be accomplished by thermal swing adsorption (TSA). TSA processes are generally known in the art for various types of adsorptive separations. Generally, TSA processes utilize the process steps of adsorption at a low temperature, regeneration at an elevated temperature with a hot purge gas, and a subsequent cooling down to the adsorption temperature. TSA processes are often used for drying gases and liquids and for purification where trace impurities are to be removed. TSA processes are often employed when the components to be adsorbed are strongly adsorbed on the adsorbent, and thus heat is required for regeneration.

A typical TSA process includes adsorption cycles and regeneration (desorption) cycles, each of which may include multiple adsorption steps and regeneration steps, as well as cooling steps and heating steps. The regeneration temperature is higher than the adsorption temperature in order to effect desorption of water, heavy hydrocarbons, and very heavy hydrocarbons. To illustrate, during the first adsorption step, which employs an adsorbent for the adsorption of heavy hydrocarbons and very heavy hydrocarbons from a gas stream (e.g., a raw natural gas feed stream), the temperature is maintained at less than 150 °F (66 °C) in some embodiments, and from about 60 °F (16 °C) to about 120 °F (49 °C) in other embodiments. In the regeneration step of the present disclosure, water, heavy hydrocarbons, and/or very heavy hydrocarbons adsorbed in the adsorbent bed initially are released from the adsorbent bed, thus regenerating the adsorbent at temperatures from about 300 °F (149 °C) to about 550 °F (288 °C) in some embodiments.

In the regeneration step, part of one of the gas streams (e.g., a stream of natural gas), the product effluent from the adsorber unit, or a waste stream from a downstream process can be heated, and the heated stream is circulated through the adsorbent bed to desorb the adsorbed components. In at least one embodiment, it is advantageous to employ a hot purge stream comprising a heated raw natural gas stream for regeneration of the adsorbent.

In at least one embodiment, the pressures used during the adsorption and regeneration steps are generally elevated at typically 700 to 1500 psig. Typically, heavy hydrocarbon adsorption is carried out at pressures close to that of the feed stream and the regeneration steps may be conducted at about the adsorption pressure or at a reduced pressure.

When a portion of an adsorption effluent stream is used as a purge gas, the regeneration may be advantageously conducted at about the adsorption pressure, especially when the waste or purge stream is re-introduced into the raw natural gas stream, for example.

While embodiments of the present disclosure are described with respect to natural gas purification processes, it is to be understood by those of ordinary skill in the art that the embodiments herein may be utilized in or adapted for use in other types of industrial applications that require hydrocarbons and/or water removal in addition to LNG and natural gas liquid (NGL) applications.

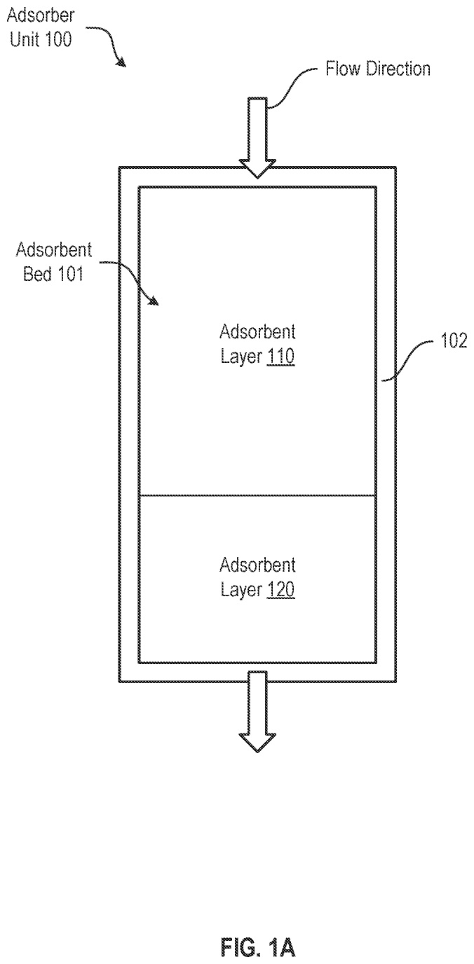

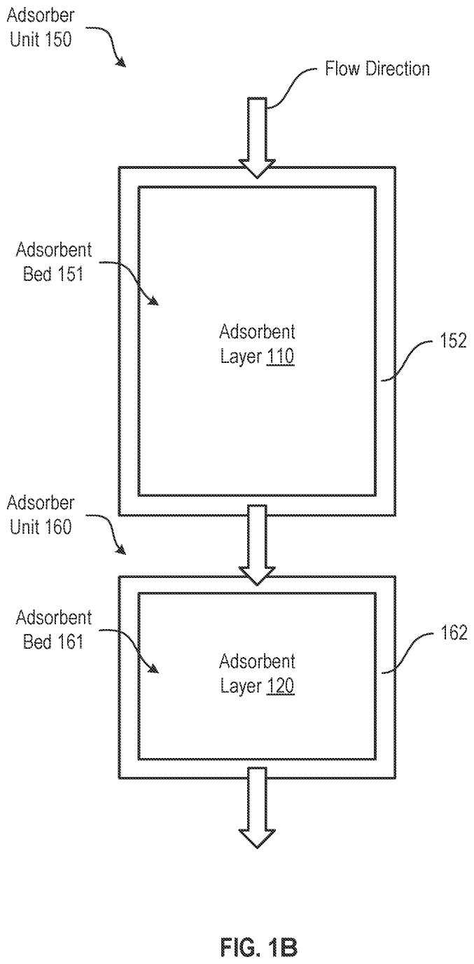

FIG. 1A illustrates an adsorber unit 100 in accordance with at least one embodiment of the disclosure, which may be adapted for use in a TSA process. In at least one embodiment, the adsorber unit 100 includes a single vessel 102 that houses an adsorbent bed 101. Other embodiments may utilize multiple vessels and adsorbent beds, for example, when implementing a continuous TSA process where one or more adsorbent beds are subject to an adsorption cycle while one or more beds are subject to a regeneration cycle. For example, the adsorber unit 100 may include, In at least one embodiment, two or more vessels and adsorbent beds that are duplicates of the vessel 102 and the adsorbent bed 101 (not shown). While the adsorbent bed 101 is subjected to an adsorption cycle, a duplicate adsorbent bed is subjected to a regeneration cycle, for example, using a product gas resulting from the adsorption cycle performed with the adsorbent bed 101.

The adsorbent bed 101 includes adsorbent layer 110 and adsorbent layer 120, contained inside a vessel 102. The flow direction indicates the flow of a gas feed stream through an inlet of the vessel 102, through the adsorbent layer 110, and then through the adsorbent layer 120 before reaching an outlet of the vessel 102. The adsorbent layer 120 is said to be downstream from adsorbent layer 110 based on this flow direction. In at least one embodiment, each adsorbent layer may comprise their respective adsorbents in a form of adsorbent beads having diameters, for example, from about 1 mm to about 5 mm. The relative sizes of the adsorbent layers is not necessarily drawn to scale, though in certain embodiments a weight percent (wt. %) of the adsorbent layer 110 with respect to a total weight of the adsorbent bed 101 (i.e., a total weight of the adsorbent layer 110 and the adsorbent layer 120) may be greater than 50 wt. %, greater than 60 wt. %, greater than 70 wt. %, greater than 80 wt. %, or greater than 90 wt. %.

In at least one embodiment, the adsorbent layer 110 comprises an adsorbent that is preferentially selective for very heavy hydrocarbons. As used herein, the terms “preferentially selective for” or “selective for” indicates that the adsorbent adsorbs the specified compound at a greater equilibrium loading compared to methane. For example, for C8+components, selectivity for C8+can be described by the following equation: selectivity =(loading C8+/concentration C8+)/(loading C1/concentration C1), where C1 is methane, and where loading is defined as moles of component adsorbed/gram of adsorbent.

In at least one embodiment, the adsorbent layer 110 comprises one or more of an amorphous silica adsorbent, an amorphous silica-alumina adsorbent, or a high-silica zeolite adsorbent. In at least one embodiment, the adsorbent layer 110 comprises an amorphous silica adsorbent and/or an amorphous silica-alumina adsorbent. Amorphous silica adsorbents and amorphous silica-alumina adsorbents may be at least partially crystalline. In at least one embodiment, an amorphous silica adsorbents or an amorphous silica-alumina adsorbent may be at least 50% amorphous, at least 60% amorphous, at least 70% amorphous, at least 80% amorphous, at least 90% amorphous, or 100% amorphous. In at least one embodiment, an amorphous silica adsorbents or an amorphous silica-alumina adsorbent may further include other components, such as adsorbed cations. An exemplary adsorbent for use in the adsorbent layer 110 may be Durasorb™M HC (available from BASF). In at least one embodiment, the adsorbent layer 110 comprises a high-silica zeolite adsorbent, such as beta zeolite, ZSM-5, Y zeolite, or combinations thereof. As used herein, “high-silica zeolite” refers to a material having a silica-to-alumina ratio, on a molar basis, of at least 5, of at least 10, of at least 20, at least 30, at least 50, at least 100, at least 150, at least 200, at least 250, at least 300, at least 350, at least 400, at least 450, or at least 500, or within any range defined therebetween (e.g., 5 to 500, 10 to 500, 10 to 400, 20 to 300, etc.). In at least one embodiment, the silica to alumina ratio is in the range of from 20 to 500.

In at least one embodiment, the adsorbent layer 120 comprises a zeolite, which may be less hydrothermally stable than the adsorbent(s) of the adsorbent layer 110. In at least one embodiment, the adsorbent layer 120 comprises one or more of zeolite A, zeolite X (e.g., zeolite 13X, which is zeolite X that has been exchanged with sodium ions), or zeolite Y. An exemplary adsorbent for use in the adsorbent layer 120 may be Durasorb™ HR4 (available from BASF). In at least one embodiment, the adsorbent layer 120 comprises one or more of zeolite 3A, zeolite 4A, zeolite 5A, or zeolite X. In at least one embodiment, the adsorbent layer 120 comprises zeolite 13X. In at least one embodiment, the adsorbent layer 120 comprises zeolite Y. In at least one embodiment, the adsorbent layer 120 comprises ZSM-5 zeolite. In at least one embodiment, the adsorbent layer 120 comprises beta zeolite. In at least one embodiment, the adsorbent layer 120 comprises zeolite 5A. In at least one embodiment, the zeolite is exchanged with any element of columns I and II of the periodic table, such as Li, Na, K, Mg, Ca, Sr, or Ba.

In at least one embodiment, an intermediate adsorbent layer may be disposed between the adsorbent layer 110 and the adsorbent layer 120 (not shown). This adsorbent layer may be used to remove additional or remaining water from the gas feed stream prior to the gas feed stream contacting the adsorbent layer 120 during an adsorption process. In at least one embodiment, the intermediate adsorbent layer comprises zeolite 3A or zeolite 4A. This intermediate adsorbent layer may be present between the adsorbent layers 110 and 120 in any of the following embodiments.

While it is contemplated that a single adsorber unit may be used with the various embodiments described herein, two or more adsorbent units may be utilized for the various embodiments described herein. FIG. 1B shows a variant of FIG. 1A, where separate adsorber units 150 and 160 are used, each having separate vessels 152 and 162, respectively, for housing adsorbent beds 151 and 161, respectively. As shown, the adsorbent layer 110 is contained in the vessel 152 of the adsorber unit 150, and the adsorbent layer 120 is contained within the vessel 162 of the adsorber unit 160, with the adsorber unit 160 being downstream from the adsorber unit 150. In at least one embodiment, when the adsorbent layer 120 comprises multiple adsorbent layers, one or more of the adsorbent layers may be separated into different adsorber units. For example, the adsorbent 120A may be present in the adsorbent bed 151 of the adsorber unit 150 (downstream from the adsorbent layer 110), and the adsorbent layer 120B may be present in the adsorbent bed 161 of the adsorber unit 160. In at least one embodiment, the adsorber unit 150 is utilized for removal of hydrocarbons, such as heavy hydrocarbons and very heavy hydrocarbons, from the gas feed stream, and the adsorber unit 160 is utilized for dehydration of the gas feed stream.

Though FIG. 1B provides a simplified view of the adsorber units 150 and 160, it is to be understood that various other components may be present, including heaters, coolers, various valves and connective elements, and controllers to regulate mass flow to, from, and between the adsorber units 150 and 160. Also, each adsorber unit 150 and 160 may include duplicate vessels and adsorbent beds used to facilitate the implementation of a continuous TSA process.

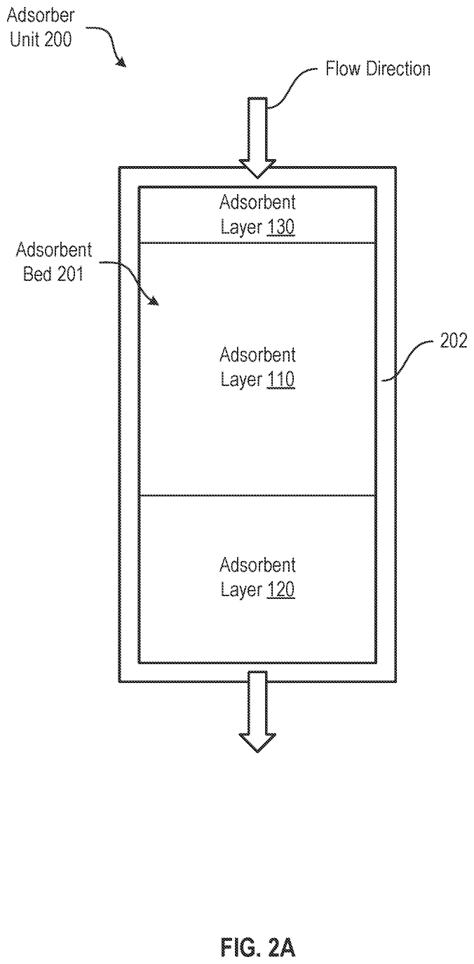

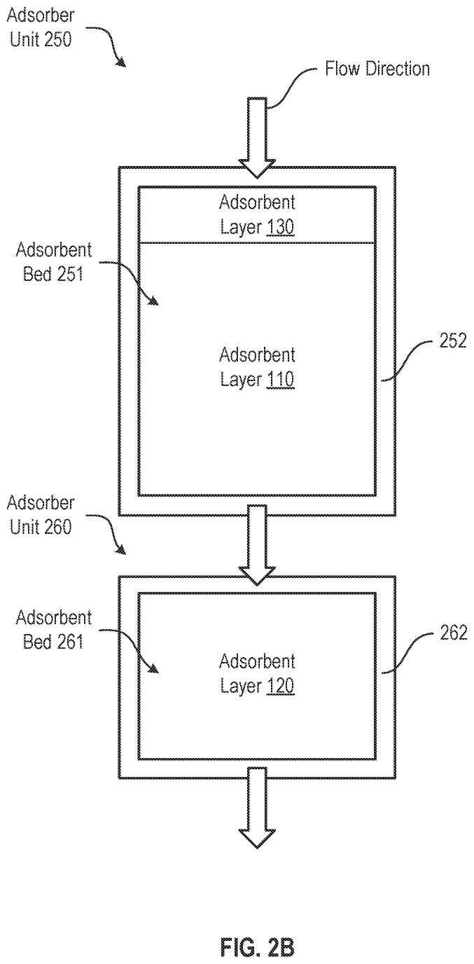

FIG. 2A illustrates a further adsorber unit 200 in accordance with at least one embodiment of the disclosure. The adsorbent bed 201 in the vessel 202 of the adsorber unit 200 is similar to the adsorbent bed 101, except that in addition to the adsorbent layer 110 and adsorbent layer 120, the adsorbent bed 201 further includes an adsorbent layer 130 immediately upstream from the adsorbent layer 110. In at least one embodiment, the adsorbent layer 130 comprises a water stable adsorbent, such as Durasorb™ HD (available from BASF), comprising, for example, silica or silica-alumina.

FIG. 2B shows a variant of FIG. 2A, where separate adsorber units 250 and 260 are used, each having separate vessels 252 and 262, respectively, for housing adsorbent beds 251 and 261, respectively. For example, the adsorbent layers 130 and 110 are contained in the vessel 252 of the adsorber unit 250, and the adsorbent layer 120 is contained within the vessel 262 of the adsorber unit 260, with the adsorber unit 260 being downstream from the adsorber unit 250. In at least one embodiment, each of the adsorbents 110, 120, and 130 may be contained within separate vessels of separate adsorber units. As discussed above with respect to FIG. 1B, duplicate adsorbent beds and vessels may be present in each of the adsorber units 250 and 260 to facilitate the implementation of a continuous TSA process.

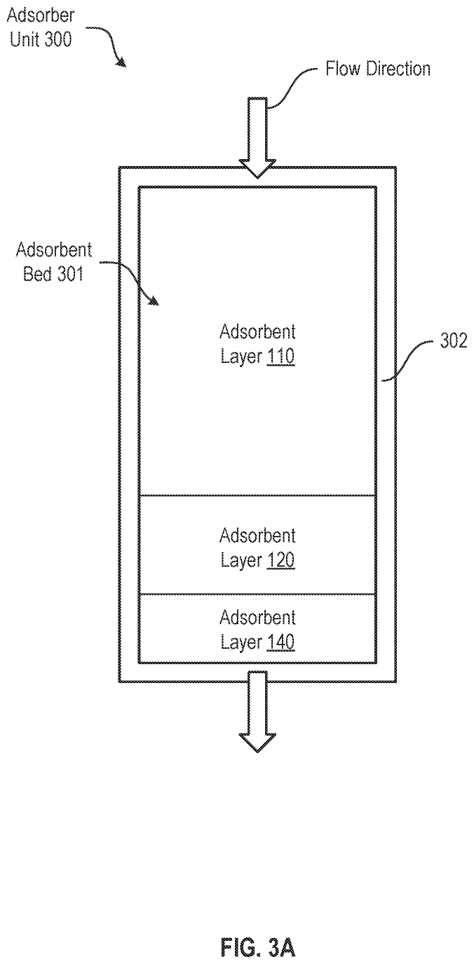

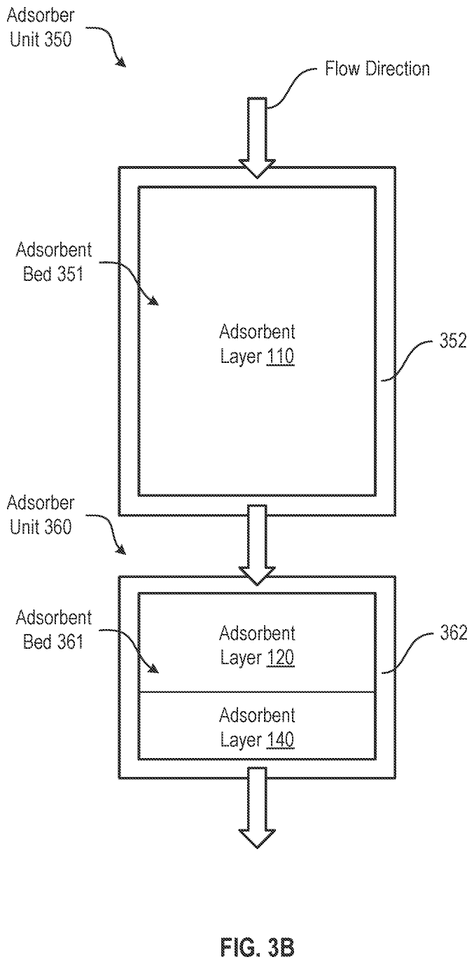

FIG. 3A illustrates a further adsorber unit 300 in accordance with at least one embodiment of the disclosure. The adsorbent bed 301 in the vessel 302 of the adsorber unit 300 is similar to the adsorbent bed 101, except that in addition to the adsorbent layer 110 and adsorbent layer 120, the adsorbent bed 301 further includes an adsorbent layer 140 immediately downstream from the adsorbent layer 120. In at least one embodiment, the adsorbent layer 140 comprises an amorphous silica adsorbent or an amorphous silica-alumina adsorbent. In at least one embodiment, the adsorbent layer 140 comprises zeolite X or zeolite Y. An exemplary adsorbent for the adsorbent layer 140 may include one or more of Durasorb™ BTX, Durasorb™M HC, or Durasorb™ AR. In at least one embodiment, when the adsorbent layer 120 comprises multiple adsorbent layers, the adsorbent layer 140 may be disposed as a sub-layer within the adsorbent layer 120.

FIG. 3B shows a variant of FIG. 3A, where separate adsorber units 350 and 360 are used, each having separate vessels 352 and 362, respectively, for housing adsorbent beds 351 and 361, respectively. For example, the adsorbent layer 110 is contained in the vessel 352 of the adsorber unit 350, and the adsorbent layers 120 and 140 are contained within the vessel 362 of the adsorber unit 360, with the adsorber unit 360 being downstream from the adsorber unit 350. In at least one embodiment, each of the adsorbent layers 110, 120, and 140 may be contained within separate vessels of separate adsorber units. In at least one embodiment, the adsorbents 110 and 120 may be in the same vessel of the same adsorber unit, and the adsorbent layer 140 may be in a separate vessel of a separate adsorber unit. As discussed above with respect to FIG. 1B, duplicate adsorbent beds and vessels may be present in each of the adsorber units 350 and 360 to facilitate the implementation of a continuous TSA process.

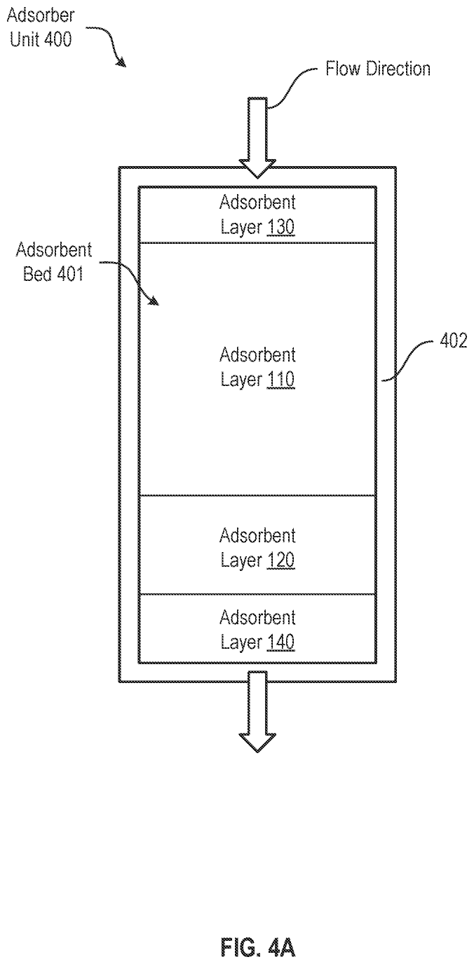

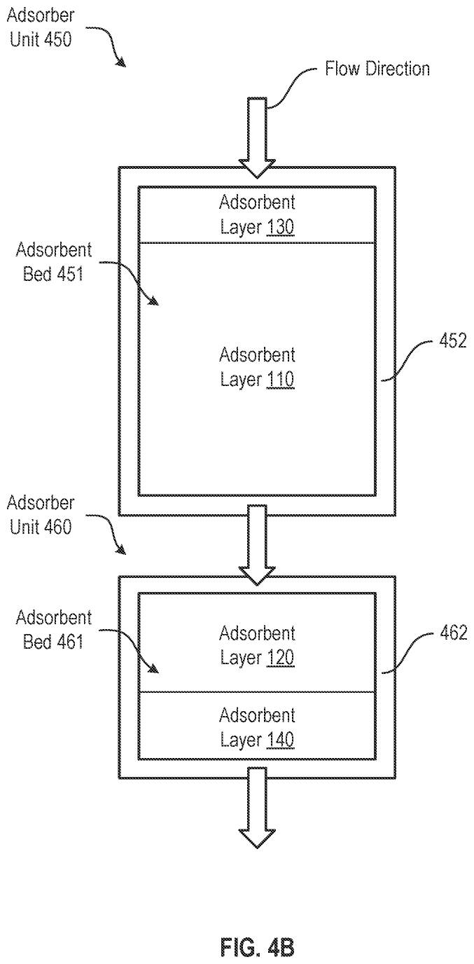

FIG. 4A illustrates a further adsorber unit 400 in accordance with at least one embodiment of the disclosure. The adsorbent bed 401 in the vessel 402 of the adsorber unit 400 may be a combination of the adsorbent bed 201 and the adsorbent bed 301 as described above.

FIG. 4B shows a variant of FIG. 4A, where separate adsorber units 450 and 460 are used, each having separate vessels 452 and 462, respectively, for housing adsorbent beds 451 and 461, respectively. For example, the adsorbent layers 110 and 130 are contained in the vessel 452 of the adsorber unit 450, and the adsorbent layers 120 and 140 are contained within the vessel 462 of the adsorber unit 460, with the adsorber unit 460 being downstream from the adsorber unit 450. In at least one embodiment, each of the adsorbent layers 110, 120, 130, and 140 may be contained within separate vessels of separate adsorber units. Other permutations of these configurations are contemplated, as would be readily understood by one of ordinary skill in the art. As discussed above with respect to FIG. 1B, duplicate adsorbent beds and vessels may be present in each of the adsorber units 450 and 460 to facilitate the implementation of a continuous TSA process.

It is contemplated that a dual-or multi-unit configuration could be applied to any of the adsorber units 100, 200, 300, or 400. In at least one embodiment, for embodiments for which the adsorbent beds are part of a TSA process, a cycle time may vary for different adsorber units in a multi-unit configuration. For example, with reference to FIG. 1B, the adsorber unit 150 (for which the adsorbent bed 151 may contain, for example, an amorphous silica adsorbent, an amorphous silica-alumina adsorbent, or a high-silica zeolite adsorbent) may be subject to a cycle time of less or equal to about 8 hours, about 7 hours, about 6 hours, about 5 hours, about 4 hours, about 3 hours, about 2 hours, or about 1 hour. The adsorber unit 160 (for which the adsorbent bed 161 may contain, for example, a zeolite) may be subject to a cycle time that is longer than that of the adsorber unit 150, such as greater than 10 hours and up to 24 hours, up to 48 hours, or up to 72 hours. Similar variations in the cycle times may be applied to each of the configurations of FIGS. 2B, 3B, and 4B.

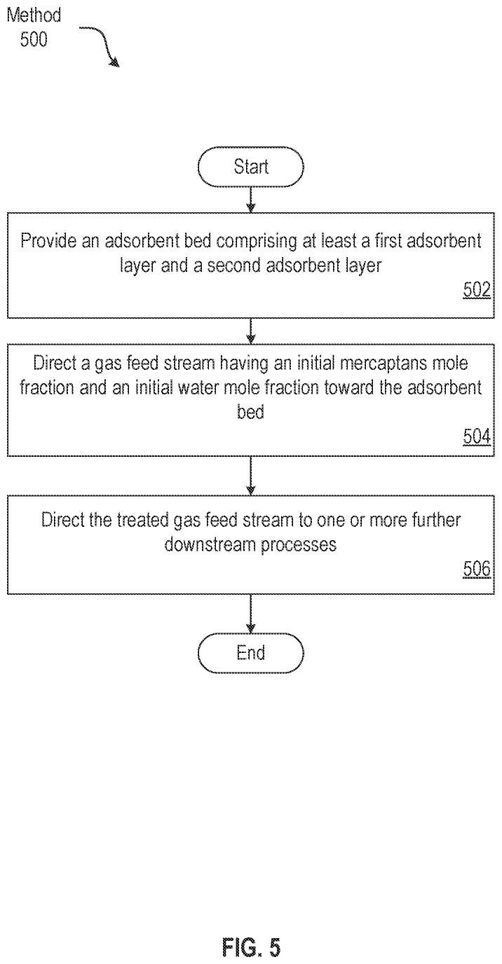

FIG. 5 illustrates a method 500 for removing water and/or hydrocarbons from a gas feed stream in accordance with an embodiment of the disclosure. At block 502, an adsorbent bed (e.g., any of adsorbent beds 101, 201, 301, 401, or modifications thereof) is provided, the adsorbent bed comprising at least a first adsorbent layer (e.g., the adsorbent layer 110) and a second adsorbent layer (e.g., the adsorbent layer 120 or the adsorbent layer 120A).

At block 504, a gas feed stream having an initial water mole fraction and an initial very heavy hydrocarbons mole fraction is directed toward the adsorbent bed. In at least one embodiment, the gas feed stream comprises a natural gas feed stream. In at least one embodiment, the gas feed stream comprises predominately methane (at least 50% methane on a molar basis). In at least one embodiment, the gas feed stream comprises predominately CO₂ (at least 50% CO₂ on a molar basis). In at least one embodiment, the contact is performed as part of a TSA process. The TSA process may have an adsorption cycle time of less or equal to about 8 hours, about 7 hours, about 6 hours, about 5 hours, about 4 hours, about 3 hours, about 2 hours, or about 1 hour.

The gas feed stream may have an initial water mole fraction and an initial very heavy hydrocarbons mole fraction prior to entering the adsorbent bed and contacting the first adsorbent layer. After passing through the first adsorbent layer, the gas feed stream has a reduced water mole fraction compared to the initial water mole fraction when the gas feed stream reaches the second adsorbent layer. The feed gas stream may also have a reduced very heavy hydrocarbons mole fraction compared to the initial very heavy hydrocarbons mole fraction when the feed gas stream reaches the second adsorbent layer. In at least one embodiment, block 504 corresponds to an adsorption step in an adsorption cycle in a TSA process. In at least one embodiment, the reduced water mole fraction is maintained for at least 90% of the duration of the adsorption step. That is, the second adsorbent layer, which is less hydrothermally stable than the first adsorbent layer, is contacted with less water than the first adsorbent layer, which increases the overall lifetime of the second adsorbent layer over several TSA cycles. In at least one embodiment, the reduced water mole fraction is maintained for at least 95%, at least 96%, at least 97%, at least 98%, at least 99%, or 100% of the duration of the adsorption step.

In at least one embodiment, the reduced water mole fraction and/or the reduced very heavy hydrocarbons mole fraction is less than or equal to about 90% of the initial water mole fraction and/or the initial very heavy hydrocarbons mole fraction, respectively. In at least one embodiment, the reduced water mole fraction and/or the reduced very heavy hydrocarbons mole fraction is less than about 80%, about 70%, about 60%, about 50%, about 40%, about 30%, about 20%, about 10%, about 9%, about 8%, about 7%, about 6%, about 5%, about 4%, about 3%, about 2%, or about 1% of the initial water mole fraction. In at least one embodiment, the reduced water mole fraction is less than about 20% of the initial water mole fraction. In at least one embodiment, the initial water mole fraction is from about 500 ppm to about 1500 ppm, while the reduced water mole fraction is less than or equal to about 500 ppm, about 450 ppm, about 400 ppm, about 350 ppm, about 300 ppm, about 250 ppm, about 200 ppm, about 150 ppm, about 100 ppm, about 50 ppm, about 40 ppm, about 30 ppm, about 20 ppm, about 10 ppm, or about 5 ppm. In other embodiments, the reduced water mole fraction is less than or equal to about 100 ppm, about 50 ppm, about 10 ppm, about 9 ppm, about 8 ppm, about 7 ppm, about 6 ppm, about 5 ppm, about 4 ppm, about 3 ppm, about 2 ppm, or about 1 ppm.

In at least one embodiment, the gas feed stream has an initial very heavy hydrocarbons mole fraction prior to entering the adsorbent bed that is from about 200 ppm to about 1000 ppm (e.g., from 200 ppm to 700 ppm, or from 200 ppm to 500 ppm). The gas feed stream may have a reduced very heavy hydrocarbons mole fraction after exiting the adsorbent bed that is less than 200 ppm or is less than or equal to about 150 ppm, about 100 ppm, about 50 ppm, about 40 ppm, about 30 ppm, about 20 ppm, about 10 ppm, or about 5 ppm. In other embodiments, the reduced very heavy hydrocarbons mole fraction is less than or equal to about 100 ppm, about 50 ppm, about 10 ppm, about 9 ppm, about 8 ppm, about 7 ppm, about 6 ppm, about 5 ppm, about 4 ppm, about 3 ppm, about 2 ppm, or about 1 ppm.

At block 506, the treated gas feed stream is directed to one or more further downstream processes, such as additional adsorption steps. In at least one embodiment, a downstream process may be forming a liquefied natural gas product from the gas feed stream if the treated gas feed stream meets cryogenic specifications. For example, final water mole fraction of the gas feed stream after leaving the adsorbent bed may be below 1 ppm or below 0.1 ppm. In at least one embodiment, a final very heavy hydrocarbons mole fraction and/or a final heavy hydrocarbons mole fraction of the gas feed stream after leaving the adsorbent bed may be below 10 ppm or below 1 ppm. In at least one embodiment, the downstream process may be forming a C2+ or C3+ natural gas liquid feed stream from the gas feed stream.

In at least one embodiment, the adsorbent bed may be regenerated using a clean dry gas stream, such as a product gas from the adsorbent bed (e.g., a treated stream leaving the adsorbent bed) or a stream external to the adsorber unit of which the adsorbent bed is a part. The term “clean dry gas stream” refers to a stream that contains between 0.1 ppm and 30 ppm water, preferably 0.1 ppm to 10 ppm water, and C5+ hydrocarbon species present at less than 50% of the concentration of the gas feed stream of those corresponding species, preferably present at less than 50% of the concentration of the gas feed stream, and most preferably present at less than 50% of the concentration of the gas feed stream. In at least one embodiment, if the second adsorbent layer is part of a separate adsorber unit than the first adsorbent layer, a clean dry gas stream from the separate adsorber unit may be used to regenerate the second adsorbent layer.

In at least one embodiment, the adsorbent bed may be retrofitted or refilled by removing and replacing at least a portion of a previously present adsorbent with one or more of the first adsorbent layer or the second adsorbent layer. Retrofitting can include installing internal insulation into the vessel (e.g., the vessel 102), changing adsorption time, changing heating time, changing cooling time, changing regeneration gas flow rate, and changing regeneration gas temperature. In at least one embodiment, a zeolite material that has been hydrothermally damaged may be replaced with a zeolite adsorbent (e.g., the adsorbent layer 120) that has not been hydrothermally damaged or still has sufficient adsorption capacity.

The following exemplary embodiments are now described:

Embodiment 1: A method of removing water and hydrocarbons from a gas feed stream comprising water and hydrocarbons during an adsorption step of an adsorption cycle, the method comprising: directing the gas feed stream having an initial very heavy hydrocarbon mole fraction and an initial water mole fraction toward an adsorbent bed, the adsorbent bed comprising: a first adsorbent layer to remove water and very heavy hydrocarbons from the gas feed stream, the first adsorbent layer comprising one or more of an amorphous silica adsorbent, an amorphous silica-alumina adsorbent, or a high-silica zeolite adsorbent; and a second adsorbent layer downstream from the first adsorbent layer to remove heavy hydrocarbons, the second adsorbent layer comprising a zeolite, wherein the gas feed stream has a reduced very heavy hydrocarbons mole fraction and a reduced water mole fraction when the gas feed stream reaches the second adsorbent layer, wherein the reduced very heavy hydrocarbons mole fraction is maintained for at least 90% of the duration of the adsorption step, and wherein the reduced very heavy hydrocarbons mole fraction is less than or equal to about 90% of the initial very heavy hydrocarbons mole fraction.

Embodiment 2: The method of Embodiment 1, wherein the reduced water mole fraction is less than about 90%, about 80%, about 70%, about 60%, about 50%, about 40%, about 30%, about 20%, about 10%, about 9%, about 8%, about 7%, about 6%, about 5%, about 4%, about 3%, about 2%, or about 1% of the initial water mole fraction.

Embodiment 3: The method of either Embodiment 1 or Embodiment 2, wherein the reduced water mole fraction is less than about 20% of the initial water mole fraction.

Embodiment 4: The method of any one of Embodiments 1-3, wherein the reduced very heavy hydrocarbons mole fraction and/or the reduced water mole fraction is/are maintained for at least 95%, at least 96%, at least 97%, at least 98%, at least 99%, or 100% of the duration of the adsorption step.

Embodiment 5: The method of any one of Embodiments 1-4, wherein the reduced very heavy hydrocarbons mole fraction and/or the reduced water mole fraction is/are maintained for 100% of the duration of the adsorption step.

Embodiment 6: The method of any one of Embodiments 1-5, wherein the reduced water mole fraction is less than or equal to about 500 ppm, about 450 ppm, about 400 ppm, about 350 ppm, about 300 ppm, about 250 ppm, about 200 ppm, about 150 ppm, about 100 ppm, about 50 ppm, about 40 ppm, about 30 ppm, about 20 ppm, about 10 ppm, or about 5 ppm.

Embodiment 7: The method of any one of Embodiments 1-6, wherein the reduced water mole fraction is less than or equal to about 100 ppm, about 50 ppm, about 10 ppm, about 9 ppm, about 8 ppm, about 7 ppm, about 6 ppm, about 5 ppm, about 4 ppm, about 3 ppm, about 2 ppm, or about 1 ppm.

Embodiment 8: The method of any one of Embodiments 1-7, wherein the reduced very heavy hydrocarbons mole fraction is less than or equal to about 200 ppm, about 150 ppm, about 100 ppm, about 50 ppm, about 40 ppm, about 30 ppm, about 20 ppm, about 10 ppm, or about 5 ppm.

Embodiment 9: The method of any one of Embodiments 1-8, wherein the adsorbent of the first adsorbent layer is selective for very heavy hydrocarbons.

Embodiment 10: The method of any one of Embodiments 1-9, wherein the first adsorbent layer comprises the amorphous silica adsorbent and/or the amorphous silica-alumina adsorbent.

Embodiment 11: The method of any one of Embodiments 1-10, wherein the zeolite of the second adsorbent layer is selective for heavy hydrocarbons.

Embodiment 12: The method of any one of Embodiments 1-11, wherein the zeolite of second adsorbent layer comprises one or more of zeolite A, zeolite X, or zeolite Y.

Embodiment 13: The method of any one of Embodiments 1-11, wherein the zeolite of the second adsorbent layer comprises one or more of zeolite 3A, zeolite 4A or zeolite 5A.

Embodiment 14: The method of any one of Embodiments 1-11, wherein the zeolite of the second adsorbent layer comprises one or more of zeolite 13X, zeolite Y, ZSM-5 zeolite, beta zeolite, or zeolite 5A.

Embodiment 15: The method of any one of Embodiments 1-14, wherein the zeolite of the second adsorbent layer is exchanged with an element selected from Li, Na, K, Mg, Ca, Sr, or Ba.

Embodiment 16: The method of any one of Embodiments 1-15, wherein the adsorbent bed further comprises an intermediate adsorbent layer between the first adsorbent layer and the second adsorbent layer to remove additional or remaining water.

Embodiment 17: The method of any one of Embodiments 1-16, wherein the intermediate adsorbent layer comprises zeolite 3A or zeolite 4A.

Embodiment 18: The method of any one of Embodiments 1-17, wherein the adsorbent bed further comprises a further adsorbent layer downstream from the second adsorbent layer, the further adsorbent layer comprising an amorphous silica adsorbent or an amorphous silica-alumina adsorbent.

Embodiment 19: The method of any one of Embodiments 1-18, wherein the adsorbent bed further comprises an initial adsorbent layer upstream from the first adsorbent layer, the initial adsorbent layer comprising a water stable adsorbent.

Embodiment 20: The method of Embodiment 19, wherein the water stable adsorbent is an amorphous silica or amorphous silica-alumina adsorbent.

Embodiment 21: The method of any one of Embodiments 1-20, wherein the gas feed stream is a natural gas feed stream.

Embodiment 22: The method of any one of Embodiments 1-21, wherein a final water mole fraction of the gas feed stream leaving the adsorbent bed is below 1 ppm or below 0.1 ppm.

Embodiment 23: The method of any one of Embodiments 1-22, wherein a final very heavy hydrocarbons mole fraction of the gas feed stream after leaving the adsorbent bed is below 10 ppm or below 1 ppm.

Embodiment 24: The method of any one of Embodiments 1-23, further comprising: forming a liquefied natural gas product from the gas feed stream after leaving the adsorbent bed.

Embodiment 25: The method of any one of Embodiments 1-23, further comprising: forming a C2+ or C3+ natural gas liquid feed stream from the gas feed stream after leaving the adsorbent bed.

Embodiment 26: The method of any one of Embodiments 1-25, wherein the contacting is performed as part of a thermal swing adsorption process having a cycle time of less or equal to about 8 hours, about 7 hours, about 6 hours, about 5 hours, about 4 hours, about 3 hours, about 2 hours, or about 1 hour.

Embodiment 27: The method of any one of Embodiments 1-27, further comprising: prior to directing the gas feed stream toward the adsorbent bed, retrofitting the adsorbent bed by removing and replacing at least a portion of a previously present adsorbent with one or more of the first adsorbent layer or the second adsorbent layer.

Embodiment 28: A natural gas purification system adapted to perform any one of the method of any one of Embodiments 1-27.

Embodiment 29: An adsorbent bed adapted for removing hydrocarbons and water from a gas feed stream, the adsorbent bed comprising: a first adsorbent layer comprising one or more of a silica adsorbent or a silica-alumina adsorbent to remove water and very heavy hydrocarbons from the gas feed stream; a second adsorbent layer downstream from the first adsorbent layer, the second adsorbent layer comprising one or more of zeolite 13X, zeolite Y, ZSM-5 zeolite, beta zeolite, or zeolite 5A; and an intermediate adsorbent layer between the first adsorbent layer and the second adsorbent layer, the intermediate adsorbent layer comprising one or more of zeolite 4A or zeolite 5A, wherein a volume ratio of the first adsorbent layer to the second adsorbent layer is selected such that contact of the gas feed stream having an initial very heavy hydrocarbons mole fraction and an initial water mole fraction with the first adsorbent layer results in a reduced very heavy hydrocarbons mole fraction and a reduced water mole fraction prior to contact with the second adsorbent layer.

Embodiment 30: A natural gas purification system comprising the adsorbent bed of Embodiment 29.

### ILLUSTRATIVE EXAMPLES

The following examples are set forth to assist in understanding the disclosure and should not, of course, be construed as specifically limiting the embodiments described and claimed herein. Such variations of the disclosed embodiments, including the substitution of all equivalents now known or later developed, which would be within the purview of those skilled in the art, and changes in formulation or minor changes in experimental design, are to be considered to fall within the scope of the embodiments incorporated herein.

### Example 1

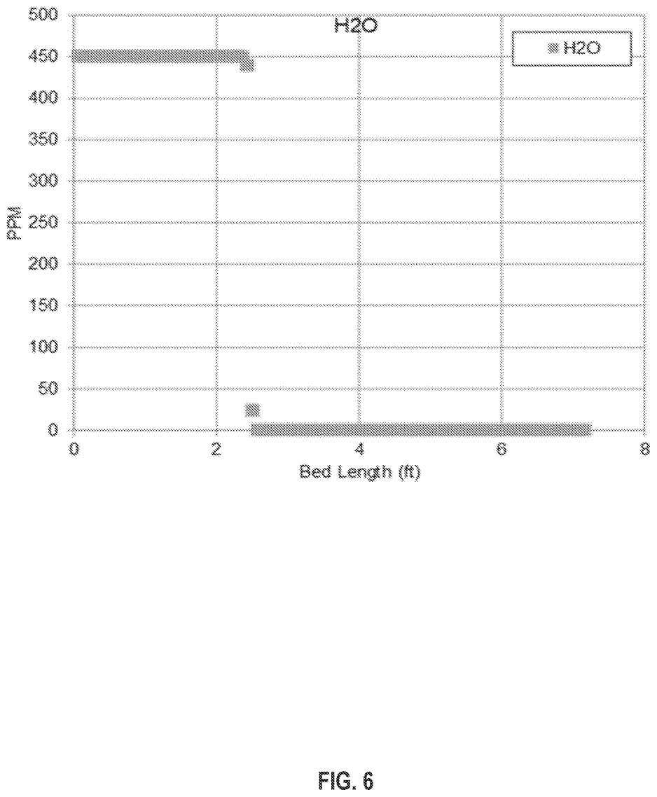

A bed of zeolite 4A (Durasorb™ HR 4) was simulated with a feed of 450 ppm of water. The bed contained 30000 kg of zeolite 4A with a volume of 43 m³. The bed was operated at a temperature of 25 °C and a pressure of 62 bara. A flow rate of 176000 Nm³/hr (normal meters cubed per hour) was simulated. FIG. 6 shows an H2O profile of a zeolite 4A bed at the end of adsorption.

### Example 2

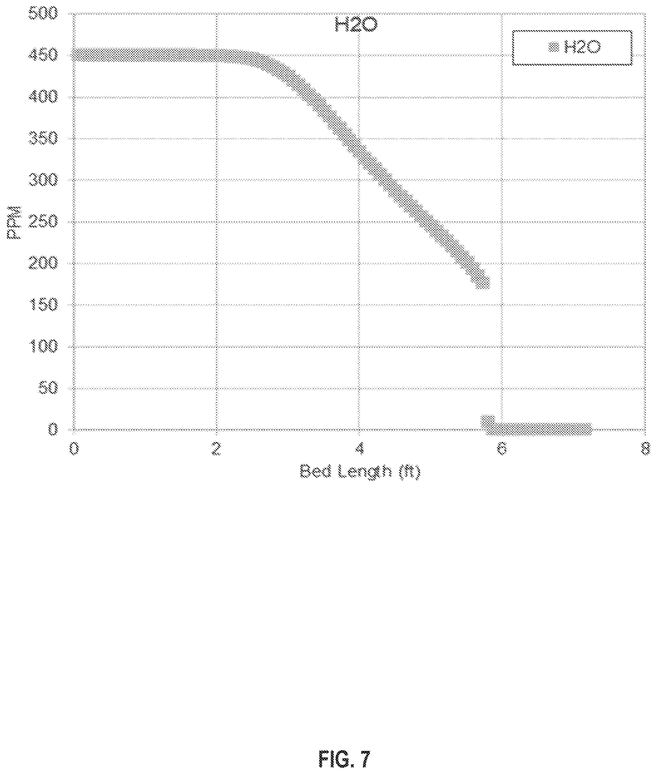

A bed of Durasorb™ HD 24000 kg and zeolite 4A was simulated with a feed of 450 ppm of water. The bed contained 6000 kg of zeolite 4A with a volume of 43 m³. The bed was operated at a temperature of 25 °C and a pressure of 62 bara. A flow rate of 176000Nm³/hr was simulated. FIG. 7 shows an H2O profile of the Durasorb™ HD and zeolite 4A bed at the end of adsorption.

### Examples 3-6

The following examples illustrate that if the water content to the zeolite 4A layer is reduced, the amount of water at elevated temperatures during regeneration of the bed can be reduced, which in turn will reduce the degree of hydrothermal damage.

The same volume (43 m3) of zeolite 4A was simulated for the remaining examples. A feed at 25 °C and 62 bar was fed to the bed. All beds were allowed to run such that the entire bed was saturated at the feed conditions. For example, in Example 3, 450 ppm of water was leaving the adsorbent bed at the end of adsorption. Similarly, in Example 6, 10 ppm of water was leaving the bed on adsorption. All beds were regenerated with 14500 Nm³/hr of gas at 295 °C.

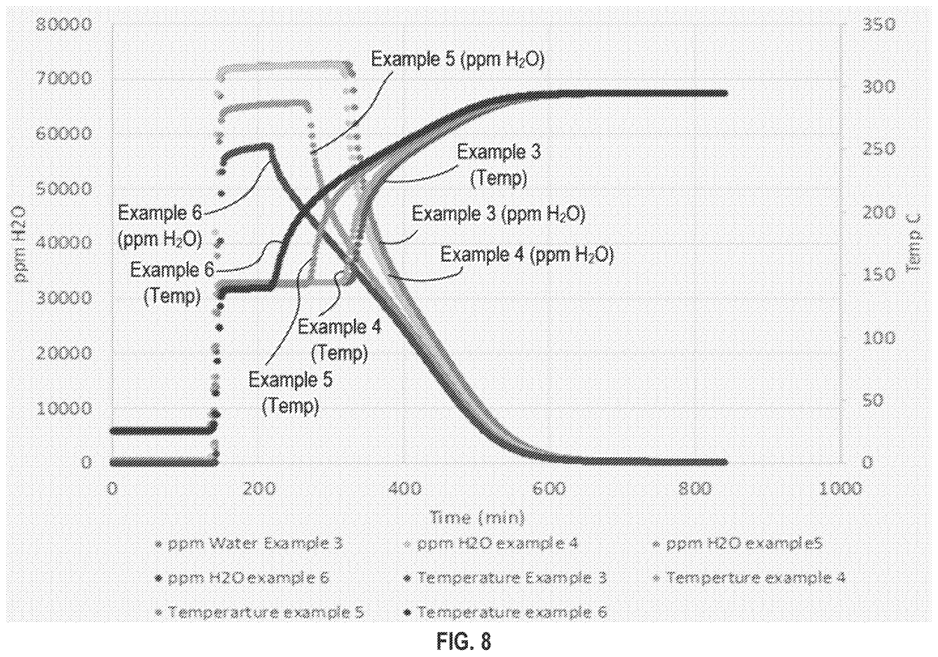

FIG. 8 shows the outlet composition and temperature for each of Example 3 (feed of 450 ppm water), Example 4 (feed of 180 ppm water), Example 5 (feed of 10 ppm water), and Example 6 (feed of 5 ppm water). As clearly illustrated, the combination of water concentration, temperature, and time was reduced as the amount of water in the feed to the zeolite section was reduced. For example, the 5 ppm water feed is at its maximum water concentration for approximately 70 minutes, whereas the 450 ppm water feed is at the maximum water concentration for 170 minutes. Not illustrated but implicit is that as the zeolite fraction of the bed is reduced at the time the zeolite will be at high concentration, water and temperature will be reduced for a fixed regeneration flow. Consequently, Examples 3-6 represent a worst case scenario such that if the zeolite was only 20% of the beds in those cases, the time scale they would be exposed to elevated water would have been reduced further by a factor of 5, thereby reducing the degree of hydrothermal damage even further for all cases.

### Example 7

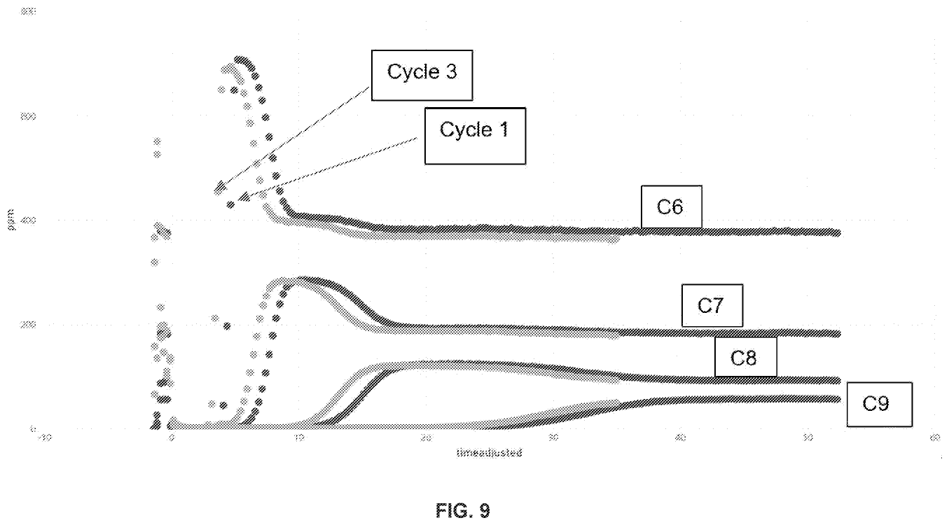

A bed was loaded with 117 grams of zeolite beta and fed a stream of 375 ppm n-C6, 184 ppm C7, 92 ppm n-C8, and 56 ppm C9. The feed flow rate for the run was 15.4 slpm at a pressure of 900 psig and at a temperature of 25 °C. After each breakthrough test the bed was regenerated with a nitrogen flow of 17 slpm at a temperature of 270 °C for a period of 4 hours. As indicated in FIG. 9, there is a decay in the midpoint of the breakthrough time for C6 from 4.5 hours to 3.7 hours.

### Example 8

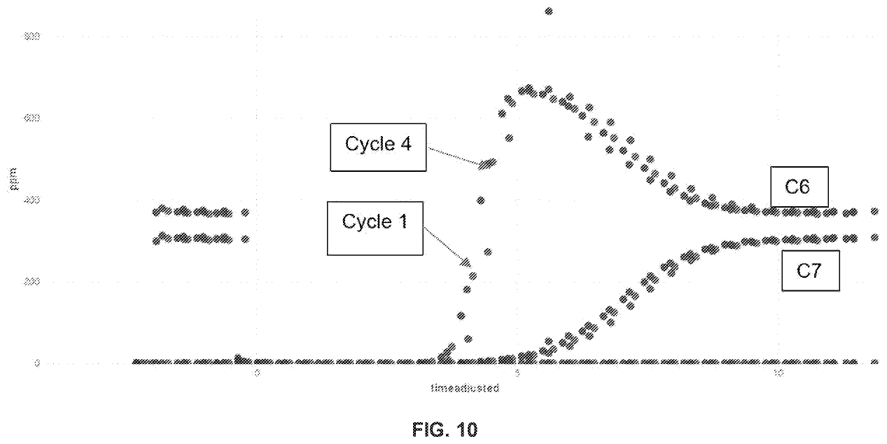

A bed was loaded with 117 grams of zeolite beta and fed a stream of 366 ppm n-C6 and 306 ppm C7. This feed had no n-C7 and no n-C8. The feed flow rate for the run was 15.4 slpm at a pressure of 900 psig and at a temperature of 25 °C. After each breakthrough test the bed was regenerated with a nitrogen flow of 17 slpm at a temperature of 270 °C for a period of 4 hours. As indicated in FIG. 10, there was a minimal decay in the midpoint of the breakthrough time for C6. This indicates that removing C8+ from the feed prior to reaching this material would be beneficial.

### Example 9

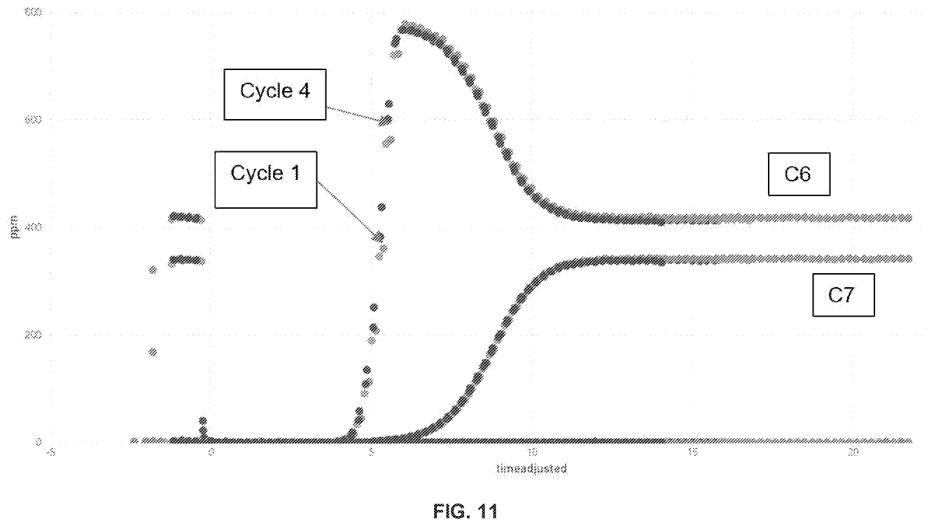

A bed was loaded with 117 grams of 13X zeolite and fed a stream of 420 ppm n-C6 and 341 ppm C7. This feed had no n-C7 and non-C8. The feed flow rate for the run was 15.4 slpm at a pressure of 900 psig and at a temperature of 25 °C. After each breakthrough test the bed was regenerated with a nitrogen flow of 17 slpm at a temperature of 270 °C for a period of 4 hours. As indicated in FIG. 11, there was a minimal decay in the midpoint of the breakthrough time for C6. This indicates that removing C8+ from the feed prior to reaching this material would be beneficial.

In the foregoing description, numerous specific details are set forth, such as specific materials, dimensions, processes parameters, etc., to provide a thorough understanding of the embodiments of the present disclosure. The particular features, structures, materials, or characteristics may be combined in any suitable manner in one or more embodiments. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion.

As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form.

Reference throughout this specification to “an embodiment”, “certain embodiments”, or “one embodiment” means that a particular feature, structure, or characteristic described in connection with the embodiment is included in at least one embodiment. Thus, the appearances of the phrase “an embodiment”, “certain embodiments”, or “one embodiment” in various places throughout this specification are not necessarily all referring to the same embodiment, and such references mean “at least one”.

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

1. A method of removing water and hydrocarbons from a gas feed stream comprising water and hydrocarbons during an adsorption step of an adsorption cycle, the method comprising:
directing the gas feed stream having an initial very heavy hydrocarbon mole fraction and an initial water mole fraction toward an adsorbent bed, the adsorbent bed comprising:
a first adsorbent layer to remove water and very heavy hydrocarbons from the gas feed stream, the first adsorbent layer comprising one or more of an amorphous silica adsorbent, an amorphous silica-alumina adsorbent, or a high-silica zeolite adsorbent; and
a second adsorbent layer downstream from the first adsorbent layer to remove heavy hydrocarbons, the second adsorbent layer comprising a zeolite,
wherein the gas feed stream has a reduced very heavy hydrocarbons mole fraction and a reduced water mole fraction when the gas feed stream reaches the second adsorbent layer,
wherein the reduced very heavy hydrocarbons mole fraction is maintained for at least 90% of the duration of the adsorption step, and
wherein the reduced very heavy hydrocarbons mole fraction is less than or equal to about 90% of the initial very heavy hydrocarbons mole fraction.

2. The method of claim 1, wherein the reduced water mole fraction is less than about 90%, of the initial water mole fraction.

3. The method of claim 1, wherein the reduced water mole fraction is less than about 20% of the initial water mole fraction.

4. The method of claim 1, wherein the reduced very heavy hydrocarbons mole fraction and/or the reduced water mole fraction is/are maintained for at least 95% of the duration of the adsorption step.

5. (canceled)

6. The method of claim 1, wherein the reduced water mole fraction is less than or equal to about 500 ppm.

7. (canceled)

8. The method of claim 1, wherein the reduced very heavy hydrocarbons mole fraction is less than or equal to about 200 ppm.

9. The method of claim 1, wherein the adsorbent of the first adsorbent layer is selective for very heavy hydrocarbons.

10. The method of any of claim 1, wherein the first adsorbent layer comprises the amorphous silica adsorbent and/or the amorphous silica-alumina adsorbent.

11. The method of claim 1, wherein the zeolite of the second adsorbent layer is selective for heavy hydrocarbons.

12. The method of claim 1, wherein the zeolite of second adsorbent layer comprises one or more of zeolite A, zeolite X, zeolite Y, zeolite 3A, zeolite 4A, zeolite 5A, zeolite 13X, ZSM-5 zeolite, or beta zeolite, and optionally the zeolite of the second adsorbent layer is exchanged with an element selected from Li, Na, K, Mg, Ca, Sr, or Ba.

13. The method of claim 1, wherein the adsorbent bed further comprises an intermediate adsorbent layer between the first adsorbent layer and the second adsorbent layer to remove additional or remaining water, and wherein the intermediate adsorbent layer optionally comprises zeolite 3A or zeolite 4A.

14. The method of claim 1, wherein the adsorbent bed further comprises a further adsorbent layer downstream from the second adsorbent layer, the further adsorbent layer comprising an amorphous silica adsorbent or an amorphous silica-alumina adsorbent.

15. The method of claim 1, wherein the adsorbent bed further comprises an initial adsorbent layer upstream from the first adsorbent layer, the initial adsorbent layer comprising a water stable adsorbent, wherein the water stable adsorbent is optionally an amorphous silica or amorphous silica-alumina adsorbent.

16. The method of claim 1, wherein the gas feed stream is a natural gas feed stream.

17. The method of claim 1, wherein a final water mole fraction of the gas feed stream leaving the adsorbent bed is below 1 ppm and/or wherein a final very heavy hydrocarbons mole fraction of the gas feed stream after leaving the adsorbent bed is below 10 ppm

18. The method of claim 1, further comprising:
forming a liquefied natural gas product from the gas feed stream after leaving the adsorbent bed; or
forming a C2+ or C3+ natural gas liquid feed stream from the gas feed stream after leaving the adsorbent bed.

19. The method of claim 1, wherein the contacting is performed as part of a thermal swing adsorption process having a cycle time of less or equal to about 8 hours.

20. The method of claim 1, further comprising:
prior to directing the gas feed stream toward the adsorbent bed, retrofitting the adsorbent bed by removing and replacing at least a portion of a previously present adsorbent with one or more of the first adsorbent layer or the second adsorbent layer.

21. A natural gas purification system adapted to perform any of the method of claim 1.

22. An adsorbent bed adapted for removing hydrocarbons and water from a gas feed stream, the adsorbent bed comprising:
a first adsorbent layer comprising one or more of a silica adsorbent or a silica-alumina adsorbent to remove water and very heavy hydrocarbons from the gas feed stream;
a second adsorbent layer downstream from the first adsorbent layer, the second adsorbent layer comprising one or more of zeolite 13X, zeolite Y, ZSM-5 zeolite, beta zeolite, or zeolite 5A; and
an intermediate adsorbent layer between the first adsorbent layer and the second adsorbent layer, the intermediate adsorbent layer comprising one or more of zeolite 4A or zeolite 5A,
wherein a volume ratio of the first adsorbent layer to the second adsorbent layer is selected such that contact of the gas feed stream having an initial very heavy hydrocarbons mole fraction and an initial water mole fraction with the first adsorbent layer results in a reduced very heavy hydrocarbons mole fraction and a reduced water mole fraction prior to contact with the second adsorbent layer.

23. A natural gas purification system comprising the adsorbent bed of claim 22.
